(19) United States
(12) Patent Application Publication
(10) Pub. No.: US 2020/0032920 A1
(43) Pub. Date: Jan. 30, 2020

(54) PNEUMATIC DIAPHRAGM ACTUATOR AND SAFETY VALVE

(71) Applicant: Neway Oil Equipment (Suzhou) Co., Ltd., Jiangsu (CN)

(72) Inventors: Haibo Liu, Suzhou, Jiangsu (CN); Wei Bo, Suzhou, Jiangsu (CN); Ting Chen, Suzhou, Jiangsu (CN)

(21) Appl. No.: 15/735,116

(22) PCT Filed: Sep. 22, 2016
(86) PCT No.: PCT/CN2016/099656

§ 371 Date: Dec. 8, 2017

(30) Foreign Application Priority Data
Jun. 30, 2016 (CN) 201610497515.6

(51) Int. Cl. F16K 31/126; F16K 17/06; F16K 3/02

(52) U.S. Cl. CPC F16K 31/1262; F16K 3/0254; F16K 17/06

(57) ABSTRACT

The disclosure discloses a pneumatic diaphragm actuator and a safety valve. The pneumatic diaphragm actuator comprises a cylinder body, a diaphragm, a diaphragm supporting seat, a lower support, a spring, a spring seat, a connecting rod connected with a valve rod, and a valve cover provided with packing and packing gland. An outer circumferential surface of the lower part of the connecting rod is in thread connection with an adjusting nut, and a lower end of the adjusting nut props against the packing gland. The valve cover is provided with a back seal step therein for supporting the packing, and a back seal detection hole. The adjustment of drift diameter test can be carried out quickly through the adjusting nut, and the back seal detection can be carried out quickly through the back seal detection hole.

### TECHNICAL FIELD OF THE INVENTION

The present disclosure relates to an actuating device for opening and closing a valve and a valve employing this actuating device, especially relates to a diaphragm-type pneumatic actuating device used by a flat gate valve and a safety valve.

### BACKGROUND OF THE INVENTION

Flat gate valves are widely used in hardware equipment of the various stages of the petroleum industry such as petroleum and natural gas production wellhead equipment, oil and gas pipelines, product oil pipelines and storage facilities. In order to meet the different functions and adapt to different working conditions and support and supply conditions, the flat gate valve has a variety of driving modes, for example, manual, single acting hydraulic, double acting hydraulic, diaphragm pneumatic and piston pneumatic modes, and the like.

The safety valve constituted by of a pneumatic diaphragm actuator and a flat gate valve docking with each other is especially suitable for wellhead safety valve applications, transportation pipelines, manifold valves and collecting pipelines. In addition, it can also be used as a casing pipe safety valve and a storage valve. The advantages of the pneumatic diaphragm actuator are light weight, easy maintenance, and trouble-free use for many years in land, offshore platforms, or the harsh environment where personnel are difficult to reside for a long time to provide support.

As the application of diaphragm actuator is gradually deepened, the design and assembly of the diaphragm actuator on the market can be improved a lot, for example, the fine adjustment of drift diameter test, the sealing form of the diaphragm cylinder and the diaphragm leaf, and the back seal test structure. Chinese invention patent CN201310102937.5 discloses a pneumatic diaphragm actuating device used by a flat gate valve, which has such defects: in fine adjustment of drift diameter test, the adjustment can only be achieved by increasing and decreasing the gaskets on the packing gland; the back seal detection hole is shared with the grease hole, and when doing back seal test of the valve rod and the valve cover, the packing must be taken out first, which is very troublesome.

Thus, the safety valve constituted by the pneumatic diaphragm actuator and the flat gate valve in the prior art, has the following defects.

1) When doing fine adjustment of drift diameter test, the current solution is to arrange gaskets at the lower limit position of the actuator (Drift Shim), and to achieve adjustment by increasing and decreasing the gaskets. The shortcoming is that every time increasing or decreasing the gaskets needs to disassemble the connecting rod and valve rod mechanism, which wastes time and energy.

2) Enhancement of the sealing performance of the diaphragm cylinder and the diaphragm is mostly achieved by transforming the structure of the diaphragm at present, such as providing a structure such as a boss on the sealing surface of the diaphragm to solve the sealing problem The disadvantages of doing so are that the bolt load will be greater when to achieve the same sealing effect, and the pre-tightening force for sealing completely relies on the diaphragm rubber itself. When the environment temperature decreases, the elasticity and ductility of the rubber will decrease significantly, so that the rubber has a reduced or no pre-tightening force, and the seal is unreliable.

3) When the safety valve is in back seal test of the valve rod and valve cover, the packing must be taken out first, which increases a lot of assemblies and test costs.

### SUMMARY OF THE INVENTION

For this purpose, in order to overcome the defects of the prior art, the present disclosure provides a pneumatic diaphragm actuator which is convenient for the adjustment of drift diameter test, has more reliable diaphragm sealing, is convenient for back seal detection and has lower cost, and the present disclosure also provides a safety valve employing the pneumatic diaphragm actuator.

To achieve the above aims, the present disclosure provides a pneumatic diaphragm actuator which comprises a cylinder body, a diaphragm and a diaphragm supporting seat provided within the cylinder body, a lower part of the cylinder body being provided with a lower support fixedly connected with a valve cover of a flat gate valve, the lower support being provided with a spring thereon, an upper end of the spring being provided with a spring seat, the spring seat being provided with a connecting rod thereon connected with a valve rod of the flat gate valve, the valve cover being further provided with packing and packing gland thereon, wherein, an outer circumferential surface of a lower part of the connecting rod is in threaded connection with an adjusting nut capable of adjusting a fixing position up and down, and a lower end of the adjusting nut has a propping-against surface propped against the packing gland; wherein, the valve cover is provided with back seal steps therein for supporting the packing, the valve rod movably goes through the back seal step, a back seal structure is provided between the valve rod and the back seal step, the valve cover is provided with a back seal detection hole communicating internally and externally with the back seal steps, and a valve grease hole is additionally provided in the flat gate valve.

Preferably, the back seal structure comprises a back seal protuberance provided on an outer circumferential surface of the valve rod and a back seal slope provided on a lower end opening edge of the back seal step. Preferably, the valve grease hole is provided on the valve cover and located below the back seal step, or is provided on the valve body of the flat gate valve.

The back seal detection hole comprises a through-hole segment and a thread hole segment that internally and externally communicating, and a sealing element provided in the back seal detection hole for sealing the through-hole segment and a screw for tightly compressing and fixing the sealing element.

In a specific embodiment, the sealing element is a steel ball, and the tail of the screw is provided with a position limitation groove corresponding to the steel ball.

Preferably, the adjusting nut is further provided with a connector thereon for locking and connecting the adjusting nut with the connecting rod.

Preferably, an upper end of the valve cover is provided with an annular step, an inner side of the step has an inner step surface corresponding to a lower end surface of the connecting rod, and an outer side of the step has an outer step surface corresponding to the propping-against surface of the adjusting nut. In specific embodiments, the height of the inner step surface is higher than the height of the outer step surface.

Wherein, the cylinder body comprises an upper diaphragm cylinder and a lower diaphragm cylinder, the upper diaphragm cylinder has an upper sealing edge, the lower diaphragm cylinder has a lower sealing edge, an edge of the diaphragm is clamped between the upper sealing edge and the lower sealing edge and is penetrated by the bolt to connect the upper sealing edge, the diaphragm and the lower sealing edge, the upper sealing edge has an upper sealing surface inclining upwardly from inside to outside, and the lower sealing edge has a lower sealing surface inclining downwardly from inside to outside.

Preferably, an angle for which the upper sealing surface inclines upwardly is 1 degree to 2 degrees; an angle for which the lower sealing surface inclines downwardly is 1 degree to 2 degrees.

In order to increase the effective contact area of the sealing surfaces and improve the sealing performance, a position where the upper sealing surface hemetically contacts the diaphragm is provided with an upper thread waterline, and a position where the lower sealing surface contacts the diaphragm is provided with a lower thread waterline.

The present disclosure further provides a safety valve, which comprises a flat gate valve including a valve body, a valve rod, a valve cover and a gate, wherein, the safety valve further comprises the pneumatic diaphragm actuator described above, the lower support is fixed on the valve cover, a lower end of the valve rod is connected to the gate, and an upper end of the the valve rod goes through the valve cover and the packing gland and then is in thread connection with the connecting rod.

The pneumatic diaphragm actuator of the present disclosure is used in the flat gate valve with fail-safe requirements, and may be used in two kinds of safety valves, i.e. fail-close safety valves and fail-open safety valves, that is, they actuate the gate to self return (safety position) when emergency circumstances occur. The present disclosure has the following advantages over the prior art.

(1) Adding the adjusting nut on the connecting rod, can fine adjust the height position of the gate quickly and conveniently when the valve closes, so that the valve achieves the qualified state of drift diameter test.

(2) When in back seal detection, the back seal detection hole is just used for the back seal detection, and is not used for injecting grease into the valve, and the packing is not required to be taken out during test, which is more convenient.

(3) In the further improvement, the sealing edge of the diaphragm cylinder employs a slope design, such that the sealing edge of the diaphragm cylinder has a certain amount of deformation, and the bolt enhances the pre-tightening force between the diaphragm cylinder and the diaphragm after being connected, so as to facilitate sealing and bolt looseness prevention.

### BRIEF DESCRIPTION OF THE DRAWINGS

FIG. 1 is a schematic sectional structure diagram of a safety valve constituted by a pneumatic diaphragm actuator of the present disclosure and a flat gate valve (omitting the valve body and the gate);

FIG. 2 is a schematic enlarged view of Part I of FIG. 1;

FIG. 3 is a schematic structure diagram of a sealing structure between the cylinder body of the pneumatic diaphragm actuator of the present disclosure and the diaphragm;

FIG. 4 is a schematic diagram of the safety valve constituted by the pneumatic diaphragm actuator of the present disclosure and the flat gate valve before drift diameter adjustment;

FIG. 5 is a schematic diagram of the safety valve constituted by the pneumatic diaphragm actuator of the present disclosure and the flat gate valve after drift diameter adjustment;

In the drawings, 1—diaphragm supporting seat; 2—spring seat; 3—connecting rod; 4—slotted set screw with cup point; 5—adjusting nut; 6—spring; 7—packing gland; 8—packing; 9—valve cover; 10—valve rod; 11—upper diaphragm cylinder; 12—bolt; 13—nut; 14—diaphragm; 15—lower diaphragm cylinder; 16—slotted set screw with cup point; 17—steel ball; 18—gate.

### DETAILED DESCRIPTION OF EXEMPLARY EMBODIMENTS

In the following, the preferable embodiments of the present application are described in detail combining with the drawings.

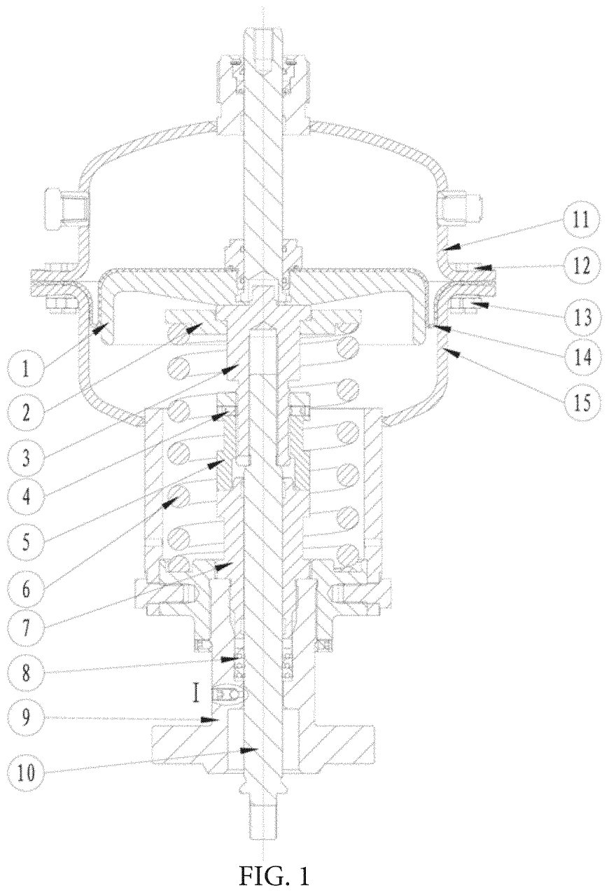

Please refer to FIG. 1 to FIG. 5, a pneumatic diaphragm actuator of the present embodiment comprises a cylinder body, a diaphragm 14 and a diaphragm supporting seat 1 provided within the cylinder body. A lower part of the cylinder body is provided with a lower supporting seat fixedly connected with a valve cover 9 of a flat gate valve, and the lower support is provided with a spring 6 thereon. An upper end of the spring 6 is provided with a spring seat 2, and the spring seat 2 is provided with a connecting rod 3 thereon connected with a valve rod 10 of the flat gate valve. The valve cover 9 is further provided with packing 8 and packing gland 7 thereon. An outer circumferential surface of a lower part of the connecting rod 3 is in thread connection with an adjusting nut 5 capable of adjusting a fixing position up and down. The valve cover 9 is provided with a back seal step therein for supporting the packing 8, the valve rod movably goes through the back seal step, and a back seal structure is provided between the valve rod 10 and the back seal step. The valve cover 9 is provided with a back seal detection hole that internally and externally communicates with the back seal step. The flat gate valve is additionally provided with a valve grease hole thereon specifically for injecting grease into the valve. The back seal structure comprises a back seal protuberance provided on an outer circumferential surface of the valve rod 10 and a back seal slope provided on a lower end opening edge of the back seal step. Wherein, the valve grease hole (not shown) is provided on the valve cover 9 and located below the back seal step, or is provided on the valve body of the flat gate valve.

The adjusting nut 5 is further provided with a connector thereon for locking and connecting the adjusting nut 5 with the connecting rod 3, in the present embodiment, the connector is a slotted set screw with cup point 4. An upper end of the adjusting nut 5 has an upper end surface propped against the step at the upper part of the periphery of the connecting rod 3, and a lower end of the adjusting nut 5 has a propping-against surface propped against the packing gland 7. Corresponding to the adjusting nut 5, an upper end of the valve cover 9 is provided with an annular step. An inner side of the annular step has an inner step surface corresponding to a lower end surface of the connecting rod 3, and an outer side of the annular step has an outer step surface corresponding to the propping-against surface of the adjusting nut 5. The height of the inner step surface is higher than the height of the outer step surface.

The pneumatic diaphragm actuator of the present embodiment is used in a flat gate valve with fail-safe requirements, and also may be used in two kinds of safety valves, i.e. fail-close safety valves and fail-open safety valves, that is, they actuate the gate to self return when emergency circumstances occur. A safety valve is formed by installing the above pneumatic diaphragm actuator onto the flat gate valve, and the flat gate valve includes a valve body, a valve rod 10, a valve cover 9 and a gate 18. The lower support of the pneumatic diaphragm actuator is fixed on the valve cover 9, a lower end of the valve rod 10 is connected to the gate 18, and an upper end of the valve rod goes through the valve cover 9 and the packing gland 7 and then is in thread connection with the connecting rod 3. It is very quick and convenient when implementing the adjustment of drift diameter test of the safety valve, the valve back seal can be detected quickly under the condition of unpacking the packing and the packing gland, and it is convenient for injecting grease into the valve.

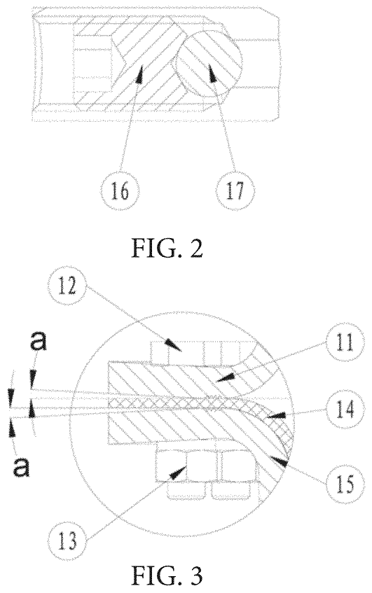

As shown in FIG. 2, the back seal detection hole comprises a through-hole segment and a thread hole segment that internally and externally communicate, and within the back seal detection hole is provided with a sealing element for sealing the through-hole segment and a screw for tightly compressing and fixing the sealing element. In the present embodiment, the sealing element is a steel ball 17, the screw for compressing the steel ball 17 is a slotted set screw with cup point 16, and the tail of the screw is provided with a position limitation groove corresponding to the steel ball 17. The slotted set screw with cup point 16 compresses the steel ball 17 at the connection of the through-hole segment and the thread hole segment, and seals the outer side opening of the through-hole segment, so as to achieve the purpose of sealing the back seal detection hole. The position limitation groove of the tail of the slotted set screw with cup point 16 is a tapered groove, and can compress the steel ball 17 tightly.

The following explain the working principle of the pneumatic diaphragm actuator with the fail-close flat gate valve.

A driving gas is injected through a gas inlet hole of the upper diaphragm cylinder 11, and acts on the diaphragm 14 to form a downward pushing force, i.e. the actuator driving force. The actuator driving force is transferred to the connecting rod 3 through the diaphragm supporting seat 1, and the connecting rod 3 on the one hand transfers part of the actuator driving force to the gate 18 through the valve rod 10 to achieve the purpose of opening the gate valve, and on the other hand transfers the rest of the actuator driving force to the spring 6 through the spring seat 2 to compress the spring 6 to reserve restoring force. During this movement, the actuator driving force is to respectively overcome the elastic force of the spring 6, the frictional force between the valve rod 10 and the packing 8, the extruding force of the valve rod 10 under the action of the valve medium pressure and the frictional force between the gate 18 and the valve seat.

When discharging the driving gas in the upper diaphragm cylinder 11, the original balance of the force is broken, the restoring force formed by the elastic force of the spring 6 and the extruding force of the valve rod 10 holds the upper hand, and respectively overcomes the frictional force between the gate 18 and the valve seat, the frictional force between the valve rod 10 and the packing 8 and the gravity of the moving parts itself, such that the valve rod 10 push the gate 18 to do return motion upwardly, and to achieve the close of the gate valve.

When the valve is in no-load, the motion process is relatively simple, and the restoring force of the driver is entirely provided by the spring 6 to overcome the frictional force of parts and the gravities of moving parts, and achieve the close operation of the valve.

As shown in FIGS. 1 and 2, the present embodiment separately provides a back seal detection hole between the packing 8 and the back seal step of the valve cover 9, and uses the slotted set screw with cup point 16 to compress the steel ball 17 to achieve seal. The safety valve differs from hand-operated valves that if a grease hole provided between the packing 8 and the back seal step of the valve cover 9 is used by the back seal detection hole and the valve grease hole together, there is no problem for detecting back seal, however, when the valve is in no-load and in a free state, grease injection will be very laborious. Because under the action of the elastic force of the spring 6, a certain sealing pressure ratio is formed at the back seal of the valve rod 10 and the valve cover 9, which obstructs the process of the grease entering into the valve chamber in a certain pressure range. While the safety valve of the present embodiment employing the above pneumatic diaphragm actuator separates the back seal detection hole and the valve grease hole to solve this problem well.

As shown in FIG. 3, the diaphragm sealing form of the pneumatic diaphragm actuator of the present embodiment is described in detail as follows.

The cylinder body comprises an upper diaphragm cylinder 11 and a lower diaphragm cylinder 15, the upper diaphragm cylinder 11 has an upper sealing edge, and the lower diaphragm cylinder 15 has a lower sealing edge. An edge of the diaphragm 14 is clamped between the upper sealing edge and the lower sealing edge and is penetrated by the bolt 12 to connect the upper sealing edge, the diaphragm 14 and the lower sealing edge, so that the bolt 12 and the nut 13 lock the upper diaphragm cylinder 11, the diaphragm 14 and the lower diaphragm cylinder 15 tightly. The upper sealing edge has an upper sealing surface inclining upwardly from inside to outside, and an angle a for which the upper sealing surface inclines upwardly is 1 degree to 2 degrees. The lower sealing edge has a lower sealing surface inclining downwardly from inside to outside, an angle for which the lower sealing surface inclines downwardly is the same with the angle a for which the upper sealing surface inclines upwardly, and also is a, and also is in the range of 1 degree to 2 degrees. In order to increase the effective contact area of the sealing surfaces and improve the sealing performance, a position where the upper sealing surface sealing contacts the diaphragm is provided with an upper thread waterline, and a position where the lower sealing surface contacts the diaphragm is provided with a lower thread waterline. The upper sealing surface and the lower sealing surface are both provided to be a slope with angle a, so that firstly it ensures the sealing contact point is above the thread waterline, and secondly the existence of the angle will cause the edges of the upper diaphragm cylinder 11 and the lower diaphragm cylinder 15 to form a certain deformation when the bolt 12 and the nut 13 compress the upper diaphragm cylinder 11, the lower diaphragm cylinder 15 and the diaphragm 14 in cooperation.

When compared with the conventional design, the possibility of sealing failure among the upper diaphragm cylinder 11, the lower diaphragm cylinder 15 and the diaphragm 14 significantly decreases when the elasticity and the ductility of rubber become lower in lower temperature condition.

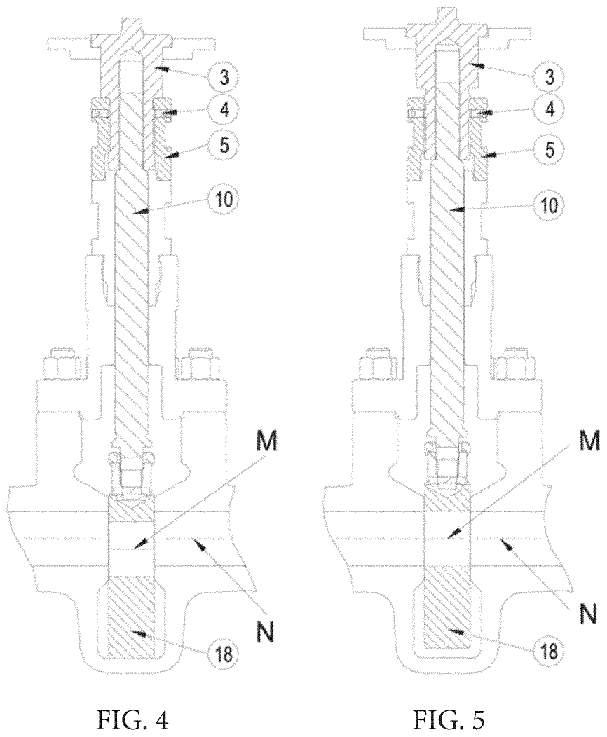

As shown in FIGS. 4 and 5, the adjusting process and the advantages of drift diameter test of the safety valve employing the pneumatic diaphragm actuator of the present embodiment are described as follows.

The adjusting nut 5 and the slotted set screw with cup point 4 are used with the connecting rod 3 in coordination, and the assembly employs an assembling manner from bottom to top. Firstly the valve rod 10 and the other parts of the valve are assembled, and the valve rod 10 and the gate 18 are pressed together downwardly to the bottom, that is, the connection between the bottom of the gate 18 and the inner bottom of the valve body. Meanwhile, the connecting rod 3 and the adjusting nut 5 are screwed clockwise to an abutting position through the thread (do not screw tightly, and two surfaces of the two parts just contact), that is, the upper end surface of the adjusting nut 5 contacts with the peripheral upper part of the connecting rod 3, and then the connecting rod 3 and the valve rod 10 are screwed clockwise tightly, and are screwed through the thread until it cannot be screwed any more. The state at this moment is shown in FIG. 4, the central line M of flow pass of the gate does not coincide with the central line N of flow pass of the valve body (M is located below N), the drift diameter gauge cannot go through at this moment. Now begin to adjust: the connecting rod 3 being kept still, screwing the adjusting nut 5 in counter-clockwise direction, the propping-against surface of the lower end of the adjusting nut 5 propping against the outer step surface of the valve cover 9, and at this moment, the connecting rod 3 beginning to move upwardly under the action of the thread, then bringing the valve rod 10 and the gate 18 to move upwardly, and inserting the drift diameter gauge when the central line M of flow pass of the gate coincides with the central line N of flow pass of the valve body, and after it is verified to be qualified, screwing the slotted set screw with cup point 4 into the adjusting nut 5 to locking the connecting rod 3 and the adjusting nut 5 tightly. The state at this moment is shown in FIG. 5, the whole adjusting process determines the relative position of the connecting rod 3 and the adjusting nut 5 in the qualified drift diameter state of the valve (the central line M of flow pass of the gate coincides with the central line N of flow pass of the valve body). And then other parts of the pneumatic diaphragm actuator such as the lower support, the spring 6 and the like are installed, and the drift diameter adjustment is accomplished in one step.

Compared with the use of gaskets for drift diameter adjustment, the pneumatic diaphragm actuator of this embodiment has the advantages of high adjusting speed, convenience, one-step and no repetitive work.

The embodiments described above are only for illustrating the technical concepts and features of the present application, and are intended to make those skilled in the art being able to understand the present application and thereby implement it, and should not be concluded to limit the protective scope of this application. Any equivalent variations or modifications according to the present application should be covered by the protective scope of the present application.

1. A pneumatic diaphragm actuator, comprising a cylinder body, a diaphragm and a diaphragm supporting seat provided within the cylinder body, a lower part of the cylinder body being provided with a lower support fixedly connected with a valve cover of a flat gate valve, the lower support being provided with a spring thereon, an upper end of the spring being provided with a spring seat, the spring seat being provided with a connecting rod thereon connected with a valve rod of the flat gate valve, the valve cover being further provided with packing and packing gland thereon, wherein, an outer circumferential surface of a lower part of the connecting rod is in threaded connection with an adjusting nut capable of adjusting a fixing position up and down, and a lower end of the adjusting nut has a propping-against surface propped against the packing gland; wherein, the valve cover is provided with a back seal step for supporting the packing, the valve rod movably goes through the back seal step, a back seal structure is provided between the valve rod and the back seal step, the valve cover is provided with a back seal detection hole communicating internally and externally with the back seal step, and a valve grease hole is additionally provided in the flat gate valve.

2. The pneumatic diaphragm actuator according to claim 1, wherein, the back seal structure comprises a back seal protuberance provided on an outer circumferential surface of the valve rod and a back seal slope provided on a lower end opening edge of the back seal step.

3. The pneumatic diaphragm actuator according to claim 1, wherein, the back seal detection hole comprises a through-hole segment and a thread hole segment for internally and externally communicating, and a sealing element provided in the back seal detection hole for sealing the through-hole segment and a screw for tightly compressing and fixing the sealing element.

4. The pneumatic diaphragm actuator according to claim 3, wherein, the sealing element is a steel ball, and the tail of the screw is provided with a position limitation groove corresponding to the steel ball.

5. The pneumatic diaphragm actuator according to claim 1, wherein, the adjusting nut is further provided with a connector thereon for locking and connecting the adjusting nut with the connecting rod.

6. The pneumatic diaphragm actuator according to claim 1, wherein, an upper end of the valve cover is provided with an annular step, an inner side of the annular step has an inner step surface corresponding to a lower end surface of the connecting rod, and an outer side of the step has an outer step surface corresponding to the propping-against surface of the adjusting nut.

7. The pneumatic diaphragm actuator according to claim 1, wherein, the cylinder body comprises an upper diaphragm cylinder and a lower diaphragm cylinder, the upper diaphragm cylinder has an upper sealing edge, the lower diaphragm cylinder has a lower sealing edge, an edge of the diaphragm is clamped between the upper sealing edge and the lower sealing edge and is penetrated by the bolt to connect the upper sealing edge, the diaphragm and the lower sealing edge, the upper sealing edge has an upper sealing surface inclining upwardly from inside to outside, and the lower sealing edge has a lower sealing surface inclining downwardly from inside to outside.

8. The pneumatic diaphragm actuator according to claim 7, wherein, an angle for which the upper sealing surface inclines upwardly is 1 degree to 2 degrees; and an angle for which the lower sealing surface inclines downwardly is 1 degree to 2 degrees.

9. The pneumatic diaphragm actuator according to claim 7, wherein, a position where the upper sealing surface hemetically contacts the diaphragm is provided with an upper thread waterline, and a position where the lower sealing surface contacts the diaphragm is provided with a lower thread waterline.

10. A safety valve, comprising a flat gate valve including a valve body, a valve rod, a valve cover and a gate, wherein, the safety valve further comprises the pneumatic diaphragm actuator according to claim 1, the lower support is fixed on the valve cover, a lower end of the valve rod is connected to the gate, and an upper end of the valve rod goes through the valve cover and the packing gland and then is in thread connection with the connecting rod.
